(19) United States
(12) Patent Application Publication
(10) Pub. No.: US 2023/0400196 A1
(43) Pub. Date: Dec. 14, 2023

(54) SMART TRAP FOR SEWERAGE, DRAINAGE AND WATER DISPOSAL SYSTEMS

(71) Applicant: Louis Martire, Brooklyn, NY (US)

(72) Inventor: Louis Martire, Brooklyn, NY (US)

(21) Appl. No.: 18/238,253

(22) Filed: Aug. 25, 2023

Related U.S. Application Data
(63) Continuation-in-part of application No. 17/670,564, filed on Feb. 14, 2022, now Pat. No. 11,739,951.
Application No. 17/670,564 is a continuation-in-part of application No. 17/207,630, filed on Mar. 20, 2021, now Pat. No. 11,732,903.
Application No. 17/207,630 is a division of application No. 16/032,116, filed on Jul. 11, 2018, now Pat. No. 10,955,143.
Application No. 16/032,116 is a division of application No. 15/271,061, filed on Sep. 20, 2016, now Pat. No. 10,718,531.

(51) Int. Cl. F24D 19/10; G08B 21/20; F24H 15/31; F24H 15/395; F24H 15/246; F24H 15/242

(52) U.S. Cl. CPC F24D 19/1015; G08B 21/20; F24H 15/31; F24H 15/395; F24H 15/246; F24H 15/242; F24D 19/1009; F24D 2220/046; F24H 15/36

(57) ABSTRACT

A residential and commercial sewerage, drainage and water disposal system and device that includes a ferrous metal cleanout plug and a pair of magnetic electrical connectors disposed in the cleanout plug, without being in physical contact with one another, where the magnetic electrical connectors are magnetically attached to the interior of the cleanout plug and retain in place an insulator plate, and where the electrical connectors are electrically connected with an alarm/control module capable of emitting and alarm and/or closing the main water supply shut off valve, so that the electrical connectors open or close an electric circuit when the fluid reaches the connectors and activates an alarm and/or and shuts off the water valve, promoting safer sewerage, drainage and water disposal system operation.

This patent application is a continuation in part of nonprovisional patent application Ser. No. 17/670,564 (Martire), filed on Feb. 14, 2022, the disclosure of which and all preceding applications is hereby incorporated by reference in its entirety.

This invention was not made pursuant to any federally-sponsored research and/or development.

### THE FIELD OF INVENTION

The system, device and method of the present invention relate to improving the safety of residential and commercial sewerage, drainage and water disposal systems. Hot and cold water have many residential and commercial uses, and water disposal systems and/or pipes are typically found in all residential and commercial houses and buildings.

### BACKGROUND OF THE INVENTION

Thus, the system, device, and method of the present invention improve the safety of the residential and commercial sewerage, drainage and water disposal systems of millions of households and commercial buildings.

The sewerage, drainage and water drainage systems may cause problems if left unattended for prolonged periods of time. If they get clogged or overfilled, such systems may cause water and sewage spills, such as in cases of sewer backup, which not only creates a water and/or sewage spill, causing damage, but is also unsanitary and potentially dangerous because sewage and drainage water may contain dangerous and harmful bacteria and other pathogens hazardous to human health and life. Organic materials in sewage decompose quickly, creating breeding grounds for bacteria and emitting odorous gases, which can also be harmful to people. Sewage poses a serious health risk to any people and animals living in the home, and sewage backups are, therefore, very dangerous. Cleaning up a sewage backup and water in the basement can be dangerous for these reasons, and can expose people to bacterial and other infections if they are not careful, making them sick.

Ordinary back water valves that exist for sewerage and water drainage systems are designed to close if the main sewer backs up. However, if the user is unaware of the problem, the water and waste will continue to be flushed into the line, creating a flood of sewage because there is no warning or alarm. Such back water valves often fail in the closed position, leaving the sewer line blocked off even if there is no stoppage, and for this reason such valves are not permitted in many jurisdictions.

What is needed is a system, device and method that can be used in residential and commercial sewerage, drainage and water disposal systems, improving the safety of these system by shutting them down if there is a backup or spill and notifying the owner of the problem.

One such device is described in nonprovisional patent application Ser. No. 17/670,564 (Martire), filed on Feb. 14, 2022, of which this application is a continuation in part and to which this application claims priority. The device is a combination of the Overflow Preventer patented in U.S. Pat. No. 10,718,531 (Martire) and U.S. Pat. No. 10,955,143 (Martire) and a modified cleanout plug that is in fluid communication with the Overflow Preventer. The device alerts the owner if there is a problem with water or sewer backup, and, in some embodiments, may shut off the flow of water to prevent further damage.

In an effort to further reduce the complexity and the costs of detecting problems in sewerage, drainage and water disposal systems, the present invention addresses the backup and overfill problem by using another solution, providing a system, device and method for notifying the owner of the leak, or alternatively shutting off water to stop the sewerage, drainage and water disposal systems water backup and alerting the owner of the backup of the system.

### SUMMARY OF THE INVENTION

It is an object of the present invention to provide a system, device and method to improve the safety of sewerage, drainage and water disposal systems. The present invention is very inexpensive to manufacture and easy to install by a qualified professional. It is a commercial and residential safety device for sewerage, drainage and water disposal systems. The present invention may be used for applications of varying scope, such as a single residential dwelling (small) to industrial applications such as a building or factory system (large).

The preferred embodiment is compact in size, inexpensive to manufacture and simple to install, providing maximum safety and economic benefit for a minimal investment of labor and materials. The system and device are easy to assemble, and the method is easy to follow according to the disclosure of the present application.

Many configurations may be used for the system, device and method of the present invention within the spirit and scope of the present invention. Although the examples and the preferred embodiments are shown primarily with sewerage, drainage and water disposal systems, the system, device and method of the present invention are equally applicable to other applications where fluid backup or overflow may be an issue. The anticipated service life of the embodiments of the present invention is at least five years.

### BRIEF DESCRIPTION OF THE DRAWINGS

A system, device and method to improve the safety of sewerage, drainage and water disposal systems of the present invention will now be described by way of example with reference to the accompanying drawings in which:

FIG. 1 is a top view of the cleanout plug of the present invention, where the magnetic contacts are electrically connected to a terminal block on the power/alarm module;

FIG. 2 is a cross sectional side view of the cleanout plug of FIG. 1, illustrating the attachment of the magnetic connectors to the cleanout plug, with an electrical insulator plate between the connectors and the interior surface of the cleanout plug and the electrical wiring connected to the magnetic contacts exiting the cleanout plug through an aperture in the top;

FIG. 3 is a bottom view of the cleanout plug of FIGS. 1-2 illustrating the attachment of the magnetic connectors to the cleanout plug, with an electrical insulator plate between the connectors and the interior surface of the cleanout plug and the electrical wiring connected to the magnetic contacts exiting the cleanout plug through an aperture in the top;

FIG. 4 is a partial enlarged top view of the optional grommet covering the aperture for the electric wiring;

FIG. 5 is a cross sectional view of the optional grommet covering the aperture for the electric wiring of FIG. 4;

FIG. 6 is a partial cross sectional view of the magnetic connector of an alternative embodiment of the present invention, without an electrical insulator plate between the magnetic connectors and the cleanout plug, but with an electrical insulator cap placed on the electrical connector;

FIG. 7 is a cross sectional side view of an alternative embodiment of the cleanout plug of FIG. 1, illustrating the attachment of the magnetic connectors to the cleanout plug, with a layer of electrical insulator material applied to the interior surface of the cleanout plug, between the connectors and the cleanout plug;

FIG. 8 is an electrical wiring diagram of the preferred embodiments including the smart trap and the alarm module illustrated in FIGS. 1-7; and

FIG. 9 is a diagram of the system and device of the present invention being used with the preferred embodiment illustrated in FIGS. 1-7 (the smart trap).

### DESCRIPTION OF THE PREFERRED EMBODIMENT

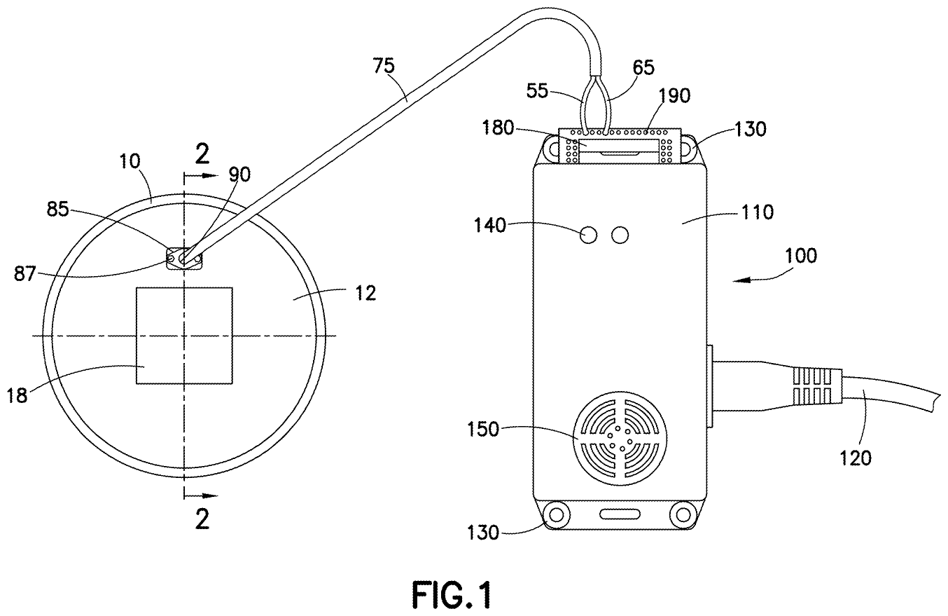

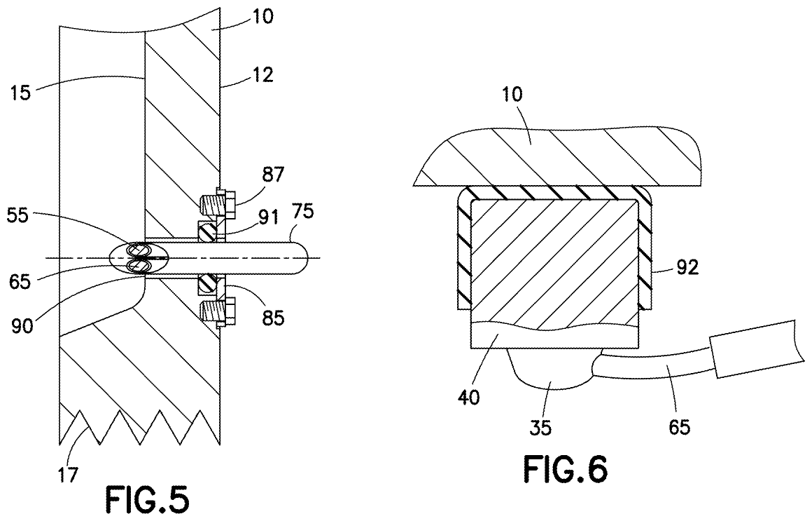

The smart trap is a sewer trap plug or cleanout plug as illustrated in FIGS. 1-6, and the device is preferably installed in the house-side cleanout aperture. Therefore, the device and system of the present invention will not interfere with the normal flow of water or sewage. If the homeowner does not have a cleanout, it makes good practical sense installing one so that an overflow preventer of the present invention may be installed.

The cleanout plug 10 is cooperatively sized to fit into a cleanout aperture that is otherwise plugged by a common cleanout plug, also called a sewer cleanout cap. Such plugs or caps are typically installed in the street-side and house-side cleanout apertures of the main sewer trap. The size of such plugs or caps is typically 4 inches in diameter, but they can also be 3 inches or 6 inches, so cleanout plugs 10 may be sized appropriately and threaded as needed to be mounted into the cleanout aperture. The envisioned method of installation of this embodiment of the device and system of the present invention is into the house-side cleanout aperture, but the device and system of the present invention may also be installed on the street side.

Threading 17 is the standard and preferred installation method, but the cleanout plugs 10 may also be installed using snaps, latches, rails, friction installations, Luer Lock connection or another connection method known in the art.

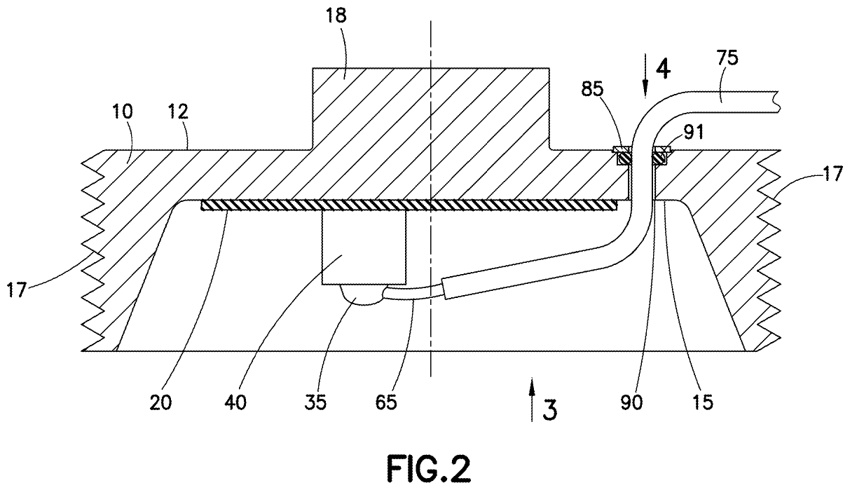

With reference to FIGS. 1-3, the cleanout plug 10 has an exterior top surface 12, an interior top surface 15, and an aperture 90 for the electrical wiring 75. Although not needed for the present invention, the cleanout plug 10 usually includes a square or the like head 18 as illustrated in FIGS. 1-2, for installation with a wrench. Since no devices such as described herein were available, the Applicant drilled an aperture for the electrical wiring in a conventional (solid) cleanout plug to create the cleanout plug 10.

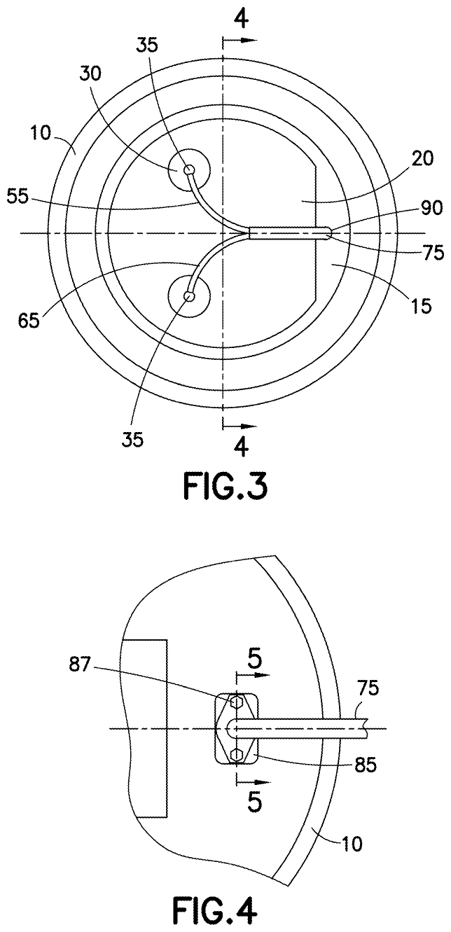

The cleanout plug 10 cooperates with a pair of electrical contacts, the first electrical contact 30 and the second electrical contact 40, which are magnetic. The magnetic electrical contacts 30 and 40 are preferably permanent magnets, but electromagnets could be used as well. The wiring 75 includes individual wires 55 and 65 that are electrically attached to the magnetic electrical contacts 30 and 40 respectively, preferably by soldered connections 35 as illustrated in FIGS. 2-3. Care should be taken not to overheat the magnetic electrical contacts 30 and 40 when soldering the wires 55 and 65, because extreme heat may demagnetize them. The wires 55 and 65 are preferably both insulated, but at least one of them must be insulated to avoid closing the electrical circuit of the device prematurely or erroneously. The wiring 75 exits the cleanout plug 10 through the aperture 90 and is connected to the alarm module 100, preferably by using terminal screws 190 of the terminal block 180 that is attached to or protrudes from the housing 110 of the alarm module 100. The alarm module is electrically powered and may have communication functions (i.e., providing the owner of the system with a message or email of the alert, as well as a visual (light/strobe) and audio (sound/buzzer sound) alarm.

A layer of electrical insulating material, the insulator 20, is placed between the electrical contacts 30 and 40 and the interior top surface 15 of the cleanout plug 10. The cleanout plug 10 is preferably ferrous (pure iron or alloy containing iron), or another magnetic metal. Cast iron is most practical in this application and is the most commonly used type, other than PVC or plastic. Although the cleanout plug could be made of magnetic metal nickel, for example, that would be more costly. The insulator 20 should be held in place by the attraction force between the magnetic electrical contacts 30 and 40 and the cleanout plug 10, but the insulator 20 can also be held in place by adhesive, hook and loop, snaps, latches, or other suitable methods.

The insulator 20 is preferably a thin plate of solid insulator material such as plastic, PVC, polyethylene, or rubber. Other electrically insulating materials may also be used, such as a ceramic or porcelain plates, but they are more expensive and brittle than other electrical insulators. The shape and size of the insulator 20 is preferably selected to be substantially close to the interior diameter of the interior top surface 15 of the cleanout plug 10, so as to prevent significant movement of the insulator 20 from side to side. Other suitable shapes can be used for the insulator 20, such as a square shape that fits inside a circle of the interior top surface 15 in the cleanout plug 10 (i.e., the diagonal of the square insulator 20 would be less than the diameter of the circle that is the interior top surface 15).

An alternative embodiment illustrated in FIG. 6 may use two smaller insulator parts 92, one preferably attached to or worn on each of the electrical contacts 30 and 40 each, so that the insulator material is positioned between the respective electrical contacts 30 and 40 and the interior top surface 15 of the cleanout plug 10. However, only one insulator part 92 would be required for the proper operation of the device, so it could be attached to either contact 30 or contact 40. Two insulator parts 92 would provide some redundancy in preventing a premature or erroneous closure of the electric circuit if one of the insulator parts 92 was dislodged. In this alternative embodiment, the smaller insulator parts 92 may be attached to the electrical contacts 30 and 40 by adhesive or as otherwise provided in this specification, or worn on each of the electrical contacts 30 and 40 like a cap if the insulator parts 92 have a bottom and a substantially vertical wall around the bottom, where the insulator caps 92 are held in place on the electrical contacts 30 and 40 by tension and/or friction and/or adhesive if necessary. The preferred materials for the insulator caps 92 would be rubber, silicone, polyethylene, and other reasonably stretchy materials. Then, the insulator caps 92 could be placed on the electrical contacts 30 and/or 40 during manufacture or installation, and reinforced with adhesive if necessary. In this embodiment, even if the magnetic electrical contacts 30 and 40 shift positions and get in physical proximity with one another, the vertical walls of the insulator caps 92 should still prevent an accidental (false) switch of the electric circuit.

Alternatively, the electrical contacts 30 and 40 may have a lip (not shown), larger in the diameter than the electrical contacts 30 and 40 themselves, and the insulator caps 92 may be made of flexible plastic or polyethylene so that they are worn on (shoehorned) around the lip and are held in place by the cooperating substantially horizontal flanges of the insulator caps 92 that extend towards the electrical contacts 30 and 40 from the substantially vertical wall and extend over the lip.

Yet another alternative embodiment may have no insulator 20 but rather use an electrically insulating coating or paint (not shown) on substantially the entire surface of the interior top surface 15. The coating or paint on the interior of the cleanout plug 10 would insulate the ferrous (magnetic) cleanout plug 10 from the electrical contacts 30 and 40, but paint or coating may wear out or chip over time, so it is not the preferred method of insulating the cleanout plug 10 from the electrical contacts 30 and 40.

Yet another alternative embodiment of the device might include a non-magnetic cleanout plug 10 (PVC or plastic), with a ferrous or magnetic plate (not shown) on top of the exterior top surface 12 of the cleanout plug 10 and strong magnetic electrical contacts 30 and 40 in the cleanout plug. Provided the top of the cleanout plug 10 is thin enough and the magnetic contacts are selected to be strong enough, the magnetic attraction will hold the magnetic electrical contacts 30 and 40 in place. In this embodiment, the insulator plate 20 would not be required because the non-magnetic cleanout plug 10 is made from an insulating material and would not short the magnetic electrical contacts 30 and 40.

In all of the embodiments an alternative embodiments above, a vertical wall (not shown) separating the magnetic electrical contacts 30 and 40 could be built into the cleanout plug 10 or the insulator plate 20 to prevent the drifting of the magnetic electrical contacts 30 and 40 close to each other to erroneously close of the electrical circuit (false positive).

With reference to FIGS. 1-2 and 4-5, the cleanout plug 10 may have an optional grommet 85 disposed on or in the exterior top surface 12. As illustrated in FIGS. 1 and 4-5, the grommet 85 may be attached to the exterior top surface 12 by screws 87, but the grommet 85 may also snap in or be inserted into a recess 91 for it in the exterior top surface 12 and held by friction/tension. The grommet 85 cooperates with the aperture 90 an enables the wiring 75 to exit the cleanout plug 10 from the top, while minimizing fluid leakage through the aperture 90 in case of a backup or overflow and protect the wiring 75 from the metallic edges of the aperture 90 in the cleanout plug 10, reducing the damage to the wiring 75 from movement, friction or rubbing. The grommet 85 is preferably made from rubber, but it can also be made from PVC, plastics, silicone, or other suitable materials.

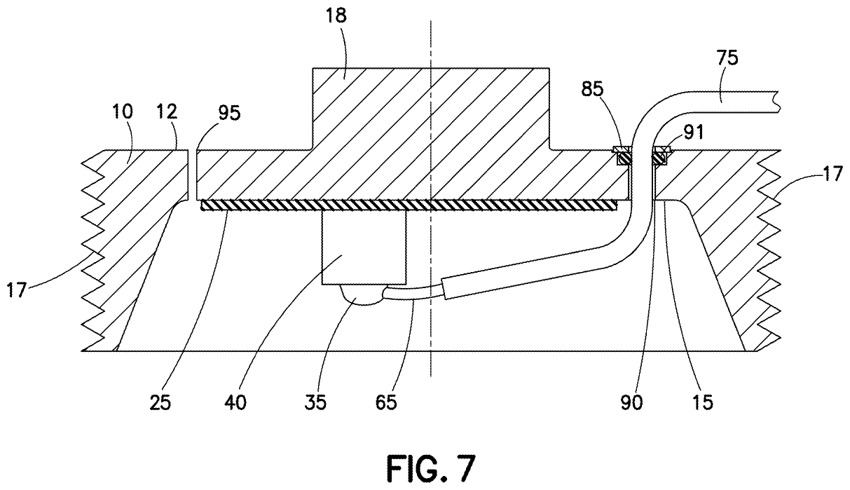

In an embodiment with or without a grommet 85, there could be an optional aperture 95 in the top of the cleanout plug 10 (between the exterior top surface 12 and the interior top surface 15). Such aperture 95 is illustrated in FIG. 7. The aperture 95 is preferably small, comparable in the diameter to 18-gauge wire, but it could have larger or smaller diameter as needed. The purpose of this aperture 95 is releasing excess air or fluid, so that the pressure does not build up inside the cleanout plug 10. Such an aperture 95 is especially useful when the grommet 85 seals or substantially seals the aperture 90, so it is more difficult for excess air or fluid to come out of the aperture 90. In the embodiment illustrated in FIG. 7, care should be taken when applying the layer of insulator material 25, so that it does not clog or plug the aperture 95. In the embodiments with the insulator 20, the insulator 20 should not cover the aperture 95, or there should be a cooperating aperture in the insulator 20 (not shown), that corresponds to the aperture 95, but can be greater than the aperture 95 in diameter.

FIG. 7 illustrates an alternative embodiment of the present invention that does not use a thin plate of electrical insulator 20, but it is using a layer of insulator material 25 that is permanently or semi-detachably applied to the interior top surface 15 of the cleanout plug 10. Multiple types of electrically-insulating coatings are available for industrial and home applications, and some of these coatings can be applied with a brush or sprayed from an aerosol can for example, such as rubber, vinyl, nylon, or other suitable plastics. When a thin layer of the insulator material 25 is applied to the interior top surface 15, it will be permanently or semi-permanently held in place after it cures/dries, even when the magnetic electrical contacts 30 and 40 cleanout plug 10.

The wiring 75 is preferably insulated wiring, containing the individual wires 55 and 65, which may be individually insulated, but at least one of which must be insulated from the other.

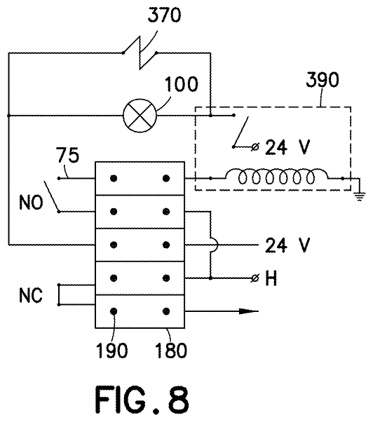

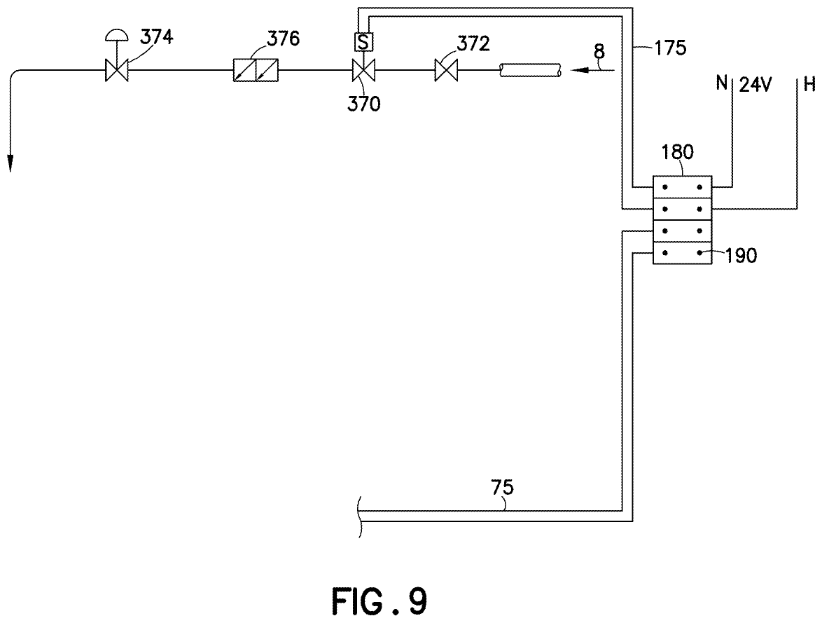

With reference to FIGS. 8-9, besides the connection to the alarm module 100, the terminal block 180 is wired to the cleanout plug 10 (the smart trap) through the electrical wiring 75, wired to the hot and neutral 24 V power, and wired to the solenoid valve 370 by the electric wiring 175. The terminal screws 190 on the terminal block 180 are used to connect the electrical wiring. The solenoid valve 370 is also connected to the manual water shut off 372 on the city water in pipe 8, a backflow preventer 376 and a pressure regulating valve 374. When the fluid backup/rising level reaches the magnetic electrical contacts 30 and 40 and activates the smart trap device, the alarm module 100 is activated and/or the device shuts off the solenoid valve 370. Closing the normally open contacts activates the solenoid valve 370 to shut off the water supply and/or alarm module 100 (audible alarm, lights, and/or wireless communication to the owner/operator of the unit).

The electrical connections to and from the terminal block 180 are illustrated in FIG. 8, where a water valve shutoff solenoid 370 is connected in series with the alarm module 100. The electric wiring 175 sends the close the valve command by opening or closing the electrical circuit of the solenoid 370 or switches from the terminal block 180 by electrical wiring 175. Alternatively, the valve may be a motorized or electrically-actuated ball valve, but in any case the closing of the valve is performed after the electrical circuit between the magnetic electrical contacts 30 and 40 is closed, regardless of whether the closing signal travels to a solenoid, electric motor, or another type of electrical actuator.

The entire electrical circuit, including smart trap, alarm, and water valve shut off is illustrated in FIG. 8, and in this embodiment the signal to close the water valve travels via the electrical wiring directly to the solenoid 370 that closes the valve, or to the electric motor or other electrical actuator of the valve.

In this and all of the described embodiments, the smart trap device (cleanout plug 10 with its connected elements) connected with a relay 390 as illustrated in FIG. 8 can perform the same functions as two separate devices. The relay can be a single pole single throw or a double pole double throw relay, and the preferred embodiment uses the double pole double throw relay 390 (a single coil-double contact points relay). The preferred relay is the double pole double throw relay 390 because it can work with one cleanout plug 10. Note that such a configuration activates the alarm and shuts down the water flow at the same time, which will be suitable for most practical uses. However, if it is desirable to provide these functions at different times, the system and device of the present invention are able to do so (i.e., activating the alarm, and then if there is no response after a certain period of time, shutting off the water).

The device and system of the present invention operate on the principle that the fluid is not coming from above, but it is coming from below, through the cleanout plug 10. In operation of the sewerage, drainage and water disposal overflow preventer, an alarm via the alarm module 100 is activated once the water reaches an unsafe level, causing the cleanout plug 10 of the device to fill with fluid (i.e., water or sewage) up to the electrical connectors 30 and 40 disposed on the interior top surface 15 of the cleanout plug 10, with the insulator plate 20 located between the electrical connectors and the interior top surface 15. The water and sewage closes the electrical connection between the magnetic electrical connectors 30 and 40, sending an electrical signal to the alarm module 100 via the electrical wiring 75.

The device sends a message to shut off the main water supply so that the backup is not made worse by use of the showers, toilets, sinks, washing machines, or dishwashers and/or triggers an alarm at the same time. It should be noted that the order of these functions is interchangeable as desired (i.e., the alarm may be activated first and the water shut off second, after a pre-programmed delay for example, or the water may be shut off first and the alarm activated second). However, in the preferred embodiment, the alarm and the water shut off are done at the same time, i.e., simultaneously, to prevent water/sewage overflow and the resulting damage and hazardous conditions.

As illustrated in FIG. 1, the alarm module 100 preferably contains an audio alarm or buzzer 150 and a lamp or light warning signal 140, but can contain just one of those devices. The alarm module 100 may be detachably or permanently mounted onto the floor, walls, or other surfaces using apertures 130 in the alarm module housing 110. Then, if the audio and/or visual warning activated by the closing of the electric circuit between the magnetic electrical contacts 30 and 40 is not heard or heeded after a while, the system shuts off the water valve by opening or closing the electrical circuit that shuts off the water valve. The alarm module 100 may have an internal power source, such as a battery, or it may be externally powered by as illustrated in FIG. 1, which illustrates the power cord 120 providing power to the alarm module 100 from an AC adapter, preferably a 24 V power supply.

The warning light and/or sound is used to alert the owners to the problem with fluid/sewage overflow, before or contemporaneously with shutting off the main water supply. The lamp or light 140 is preferably an LED or fiber optic light, and the audio alarm or buzzer 150 is preferably a speaker or piezo- or electric buzzer or other sound emitter. They are preferably built into the alarm module housing 110 of the present invention, together with control electronics and wiring to activate them, and an interior or exterior power source to power them, which is preferably a power supply that plugs into an electrical outlet and provides 24 V power through the power cord 120 and may optionally include a replaceable or rechargeable backup battery.

The electrical connections to and from the terminal block 180 are illustrated in FIG. 1, where terminal screws 190 may be used to connect all electrically-activated devices, including the water shut-off valve, and the electric wires 55 and 65, connected to the magnetic electrical contacts 30 and 40 respectively. The terminal block 180 is preferably attached to the housing 110 as illustrated in FIG. 1.

Although not necessary to the operation of the system and device of the present invention, to improve the safety of sewerage, drainage and water disposal systems, the system and device may include electrical and/or electronic control and/or monitoring circuits and mechanisms, monitoring the water/sewerage flow through the pipe, using various optical, electrical, mechanical, and other sensors positions in or about the system and device.

This device and system can detect the water or sewerage backing up before the damage is done, shut off the water to immediately stop the backup, and notify the owner of the problem, avoiding a very messy, unsanitary, and hazardous issue.

The alarm housing 110 and the alarm module 100 perform other functions, such as activating a visual or sound alarm, or by initiating a landline or cellular telephone call, email or text message to the owner, possibly over the Wi-Fi home network.

In an alternative embodiment, the system and device may include a controller or a programmable controller to further improve the efficiency of the system and device of the present invention. Such a controller may include a number of programs and/or settings that take into consideration the communications and warnings/alarms to the operator or owner via the alarm module or other communication means such as telephone or Wi-Fi. The controller may be an independent computer, a chip-based controller, or a different controller known in the art.

These configurations will enable the system and device disclosed in the specification of the present invention to improve the safety of the sewerage, drainage and water disposal systems.

Anyone can use the system and device of the present invention to improve the safety of sewerage, drainage and water disposal systems, providing additional safety, cost savings, and other benefits of safer, more efficient operation. The dimensioning and sizing of the system and device of the present invention to improve the safety of such systems, may be easily determined by those skilled in the art, but the applicant envisions that the system and device may be made with varying sizes, height/length, width/diameter, and other parameters.

While the system and device to improve the safety of as sewerage, drainage and water disposal systems, of the present invention have been shown and described in accordance with the preferred and practical embodiments thereof, it is recognized that departures from the instant disclosure are contemplated within the spirit and scope of the present invention. Therefore, the true scope of the invention should not be limited by the abovementioned description of the preferred embodiments since other modifications may become apparent to those skilled in the art upon a study of the drawings, description, explanations, and specifications herein. Various modifications to these embodiments will be readily apparent to those skilled in the art, and the principles described herein can be applied to other embodiments without departing from the spirit or scope of the invention and the subject matter of the present invention.

What is claimed is:

1. A sewerage, drainage and water disposal system overflow preventer device, comprising:
a. a ferrous metal cleanout plug suitable for installation into a cleanout aperture of a sewerage or drainage system, the cleanout plug having a longitudinal bore therethrough and a closed top having an exterior top surface and an interior top surface;
b. a first magnetic electrical connector and a second magnetic electrical connector attached to the interior top surface so that the first magnetic electrical connector and the second magnetic electrical connector are not in physical contact with one another, said first and second magnetic electrical connectors having at least a first activating function and each of the first and second magnetic electrical connectors being electrically connected to an alarm module by an electrical wire passing through an aperture in the closed top, activating the first activating function when fluid reaches the first magnetic electrical connector and the second magnetic electrical connector, opening or closing an electrical circuit connected to the magnetic electrical connectors; and
c. an electrical insulator plate for preventing a premature activating of the first activating function, wherein the electrical insulator plate is disposed between the interior top surface and at least one of the first magnetic electrical connector and the second magnetic electrical connector and is retained in place by magnetic attraction between the closed top and the at least one of the first magnetic electrical connector and the second magnetic electrical connector.

2. The sewerage, drainage and water disposal system overflow preventer device of claim 1, wherein the first activating function is activating an audio or visual alarm in the alarm module when the fluid reaches both magnetic electrical connectors.

3. The sewerage, drainage and water disposal system overflow preventer device of claim 1, wherein the alarm module includes one or more of a visual alarm, an audio alarm, a telephone communication alarm, a text alarm, an email communication alarm, a data alarm, and a network communication alarm.

4. The sewerage, drainage and water disposal system overflow preventer device of claim 1, wherein the at least a first activating function includes a first activating function and a second activating function.

5. The sewerage, drainage and water disposal system overflow preventer device of claim 4, wherein the second activating function is shutting off a main water supply valve.

6. The sewerage, drainage and water disposal system overflow preventer device of claim 5, wherein a solenoid, motor or electric actuator shuts off the main water supply valve.

7. The sewerage, drainage and water disposal system overflow preventer device of claim 6, wherein the alarm module includes a terminal block for connecting the electrical wires from the magnetic electrical connectors to the alarm module unit solenoid, motor or electric actuator, said terminal block being mounted exteriorly to the alarm module housing and having a plurality of terminal block screws for selectively connecting the electrical wires from the magnetic electrical connectors to the solenoid, motor or electric actuator.

8. The sewerage, drainage and water disposal system overflow preventer device of claim 1, wherein the electrical insulator plate is cooperatively sized to cover substantially the entire interior top surface.

9. The sewerage, drainage and water disposal system overflow preventer device of claim 8, wherein the electrical insulator plate is disposed between the interior top surface and both of the first magnetic electrical connector and the second magnetic electrical connector.

10. The sewerage, drainage and water disposal system overflow preventer device of claim 1, further comprising a cooperating grommet mounted in the exterior top surface to form a fluid-resistant seal around the electrical wires exiting through the aperture.

11. The sewerage, drainage and water disposal system overflow preventer device of claim 1, further comprising an electrical relay to enable the magnetic electrical connectors to perform a second activating function.

12. A sewerage, drainage and water disposal system overflow preventer device, comprising:
d. a ferrous metal cleanout plug suitable for installation into a cleanout aperture of a sewerage or drainage system, the cleanout plug having a longitudinal bore therethrough and a closed top having an exterior top surface and an interior top surface; and
e. a first magnetic electrical connector and a second magnetic electrical connector, at least one of said first and said second magnetic electrical connectors having an electrical insulator cap thereon, said first and said second electrical connectors attached to the interior top surface so that the first magnetic electrical connector and the second magnetic electrical connector are not in physical contact with one another and the electrical insulator cap is disposed between the interior top surface and the at least one of said first and said second magnetic electrical connectors, said first and second magnetic electrical connectors having at least a first activating function and each of the first and second magnetic electrical connectors being electrically connected to an alarm module by an electrical wire passing through an aperture in the closed top, activating the first activating function when fluid reaches the first magnetic electrical connector and the second magnetic electrical connector, opening or closing an electrical circuit connected to the magnetic electrical connectors.

13. The sewerage, drainage and water disposal system overflow preventer device of claim 12, wherein the first activating function is activating an audio or visual alarm in the alarm module when the fluid reaches both magnetic electrical connectors.

14. The sewerage, drainage and water disposal system overflow preventer device of claim 12, wherein the alarm module includes one or more of a visual alarm, an audio alarm, a telephone communication alarm, a text alarm, an email communication alarm, a data alarm, and a network communication alarm.

15. The sewerage, drainage and water disposal system overflow preventer device of claim 12, wherein the at least a first activating function includes a first activating function and a second activating function.

16. The sewerage, drainage and water disposal system overflow preventer device of claim 15, wherein the second activating function is shutting off a main water supply valve.

17. The sewerage, drainage and water disposal system overflow preventer device of claim 16, wherein a solenoid, motor or electric actuator shuts off the main water supply valve.

18. The sewerage, drainage and water disposal system overflow preventer device of claim 17, wherein the alarm module includes a terminal block for connecting the electrical wires from the magnetic electrical connectors to the alarm module unit solenoid, motor or electric actuator, said terminal block being mounted exteriorly to the alarm module housing and having a plurality of terminal block screws for selectively connecting the electrical wires from the magnetic electrical connectors to the solenoid, motor or electric actuator.

19. The sewerage, drainage and water disposal system overflow preventer device of claim 12, further comprising a cooperating grommet mounted in the exterior top surface to form a fluid-resistant seal around the electrical wires exiting through the aperture.

20. A method of installing a sewerage, drainage and water disposal system overflow preventer device, comprising:
a. providing a ferrous metal cleanout plug suitable for installation into a cleanout aperture of a sewerage or drainage system, the cleanout plug having a longitudinal bore therethrough and a closed top having an exterior top surface and an interior top surface, wherein the cleanout plug includes an aperture for electric wires in the closed top;
b. providing an electrical insulator plate for preventing a premature activating of the first activating function, wherein the electrical insulator plate is disposed between the interior top surface and at least one of the first magnetic electrical connector and the second magnetic electrical connector and is retained in place by magnetic attraction between the closed top and the at least one of the first magnetic electrical connector and the second magnetic electrical connector
c. attaching a first magnetic electrical connector and a second magnetic electrical connector to the interior top surface so that the first magnetic electrical connector and the second magnetic electrical connector are not in physical contact with one another, with the electrical insulator plate retained between the interior top surface and at least one of the first and the second magnetic electrical connectors, said first and second magnetic electrical connectors having at least a first activating function and each of the first and second magnetic electrical connectors being electrically connected to an alarm module by an electrical wire passing through the aperture in the closed top, activating the first activating function when fluid reaches the first magnetic electrical connector and the second magnetic electrical connector, opening or closing an electrical circuit connected to the magnetic electrical connectors; and
d. installing the cleanout plug into a cleanout aperture of a sewerage or drainage system, wherein the fluid activates the first activating function when the fluid reaches the first and the second magnetic electrical switches, opening or closing an electrical circuit.

21. The method of installing a sewerage, drainage and water disposal system overflow preventer device of claim 20, further comprising detecting a fluid overflow inside the cleanout plug by closing an electrical circuit when the fluid reaches the first magnetic electrical connector and the second magnetic electrical connector.

22. A sewerage, drainage and water disposal system overflow preventer device, comprising:
a. a ferrous metal cleanout plug suitable for installation into a cleanout aperture of a sewerage or drainage system, the cleanout plug having a longitudinal bore therethrough and a closed top having an exterior top surface and an interior top surface;
b. a first magnetic electrical connector and a second magnetic electrical connector attached to the interior top surface so that the first magnetic electrical connector and the second magnetic electrical connector are not in physical contact with one another, said first and second magnetic electrical connectors having at least a first activating function and each of the first and second magnetic electrical connectors being electrically connected to an alarm module by an electrical wire passing through an aperture in the closed top, activating the first activating function when fluid reaches the first magnetic electrical connector and the second magnetic electrical connector, opening or closing an electrical circuit connected to the magnetic electrical connectors; and
c. a layer of electrical insulator material for preventing a premature activating of the first activating function, wherein the layer of electrical insulator material is applied to the interior top surface between the interior top surface and at least one of the first magnetic electrical connector and the second magnetic electrical connector.

23. The sewerage, drainage and water disposal system overflow preventer device of claim 22, wherein the layer of electrical insulator material covers substantially the entire interior top surface.
